(19) United States
(12) Patent Application Publication
(10) Pub. No.: US 2013/0180367 A1
(43) Pub. Date: Jul. 18, 2013

(54) ADJUSTABLE WRENCH

(71) Applicant: Min Wang, Hangzhou City (CN)

(72) Inventor: Min Wang, Hangzhou City (CN)

(73) Assignees: HANGZHOU GREAT STAR INDUSTRIAL CO., LTD., Hangzhou City (CN); HANGZHOU GREAT STAR TOOLS CO., LTD., Hangzhou City (CN)

(21) Appl. No.: 13/356,027

(22) Filed: Jan. 23, 2012

(30) Foreign Application Priority Data
Jan. 17, 2012 (CN) 201210014287.4

(51) Int. Cl. B25B 13/14

(52) U.S. Cl. 81/170

(57) ABSTRACT

The invention discloses an adjustable wrench, including a wrench body and a worm; the wrench body includes a handle and a working part; the working part includes a fixed member, a movable member and a track; the lower portion of the movable member, whose bottom edge is arranged with a tooth part, is arranged in the track; the working part also includes a through hole in which the worm is arranged for meshing with the tooth part; when the worm is rotated, the worm interacts with the tooth part and drives the movable member to move in the directions towards or away from the fixed member; wherein the worm has at least two starts of threads. The adjustable wrench of this invention enables swift adjustments to the spacing between the movable member and the fixed member and increases the bearable torque of the worm.

### FIELD OF THE INVENTION

The invention relates to a wrench, and more particularly to an adjustable wrench.

### DESCRIPTION OF THE PRIOR ART

An adjustable wrench, which generally includes a wrench body, a worm, a pin axle and a spring, etc., is a tool for fastening or loosening screws or nuts with angled head.

The wrench body includes a handle and a working part. The working part includes a fixed member, a movable member and a track. The lower end of the movable member is arranged in the track, moving in the directions towards or away from the fixed member. The bottom edge of the lower end is arranged with a tooth part meshing with the thread of the worm. Due to the fact that the thread of the worm is meshing with the tooth part at the bottom edge of the lower end of the movable member, by rotating the worm, the movable member can be driven to move in the directions towards or away from the fixed member along the track.

In the prior art, the thread of the worm has one start, called single-start thread. The movable member has a fairly low moving speed when the worm is rotated, and the bearable torque of the single-start worm is rather small.

### SUMMARY OF THE INVENTION

In view of the above defects with the prior art, the present invention aims to solve the technical problem by providing an adjustable wrench that enables swift adjustments to the spacing between the movable member and the fixed member, and can increase the bearable torque of the worm.

In order to realize the above purpose, the invention provides an adjustable wrench, which includes a wrench body and a worm; the wrench body includes a fixed member, a movable member and a track; the lower end of the movable member, whose bottom edge is arranged with a tooth part, is arranged in the track; the working part also includes a through hole in which the worm is arranged for meshing with the tooth part; when the worm is rotated, the worm commences functioning with the tooth part and drives the movable member to move in the directions towards or away from the fixed member; wherein the number of starts on the thread of the worm is at least two.

Preferably, of the adjustable wrench, the number of starts on the thread of the worm is two.

Preferably, the adjustable wrench also includes a pin axle and a pin hole, the pin hole is arranged on the wrench body, the pin axle passes through the pin hole and is arranged axially in the worm, and the worm is rotatable around the pin axle. Further, one end of the pin axle is flush with the top of the pin hole.

In a further preferred embodiment, the adjustable wrench also includes a spring, which is arranged between the worm and the wrench body, and the pin axle is arranged to extend axially through the spring.

Preferably, the thread tooth profile of the worm is in a shape of arc with an angled top. Further, the tooth part at the bottom edge of the lower end of the movable member has a flat top.

Preferably, the cross-sectional shape of the through hole is approximately a rectangle.

In a further alternative embodiment, the through hole has a T-shape groove on each side, and each of the two axial end surfaces of the worm has a boss which matches the T-shape groove when the worm is installed in the through hole.

Preferably, the tooth part is approximately in a shape of a half circle, triangle or trapezoid.

The adjustable wrench of the present invention has a worm having at least two starts, which enables swift adjustment of the spacing between the movable member and the fixed member and increases the bearable torque of the worm. The adjustable wrench of the present invention solves the technical problem that people have been craving to solve but have not succeeded so far.

Secondly, the spring of the adjustable wrench of the present invention is arranged between the worm and the wrench body with its two ends engaging respectively against the worm and the wrench body, where the pressure force is produced in the direction of the movable member moving away from the fixed member. Thus, by the pressure force produced, the worm can not rotate randomly by itself when an operator is not rolling it, so as to ensure the movable member and the worm can bear forces reliably while clamping work pieces.

Moreover, the present invention has made adjustments to the tooth profile of the thread, changing the original trapezoidal thread of normal profile to an arc shape surface and the top of the thread is designed with an angle to avoid interference, and meanwhile, the flat top of the tooth part of the gear of the movable member engaging the worm makes the worm come closer to the gear so that the engagement area between the worm and the gear is increased for enhancing the torque transmission and the reliability of the worm's self-lock function.

Furthermore, on the both sides of the wrench body of the present invention are added two T-shape grooves, and also on two end surfaces of the worm are added two bosses that match with T-shape grooves to increase the bearable torque of the worm. Due to the existence of the gaps between each other part of the adjustable wrench, certain component force is received by the worm when the wrench is receiving forces, and the component force is stronger when using double-start than using single-start, which further increases the force which the tooth part receives. On one hand, the design of the structure can increase bearable component force of the worm; on the other hand, demand is lowered for matching accuracy between the other parts of the wrench.

Referencing now to the figures, the conception, detailed structure and induced technical effect of the present invention will be expounded for due understanding of the purpose, characterizations and effects of the present invention:

### BRIEF DESCRIPTION OF THE DRAWINGS

FIG. 1 shows a front view of the fixed member engagingly fits the movable member as in the first embodiment of the present invention.

FIG. 2 is a cross-sectional view in the A-A orientation of the embodiment shown in FIG. 1.

FIG. 3 is a vertical view of the embodiment shown in FIG. 1.

FIG. 4 shows a front view of the fixed member departing from the movable member as in the first embodiment of the present invention.

FIG. 5 is a cross-sectional view in the A-A orientation of the embodiment shown in FIG. 4.

FIG. 6 shows a schematic view of the second embodiment of the present invention of the thread tooth profile of the worm.

FIG. 7 shows a front view of the movable member of the second embodiment.

FIG. 8 is a vertical view of the embodiment shown in FIG. 7.

FIG. 9 shows a structural schematic view of the third embodiment of the wrench body.

FIG. 10 shows a structural schematic view of the third embodiment of the worm with bosses.

### DETAILED DESCRIPTION OF THE PREFERRED EMBODIMENTS

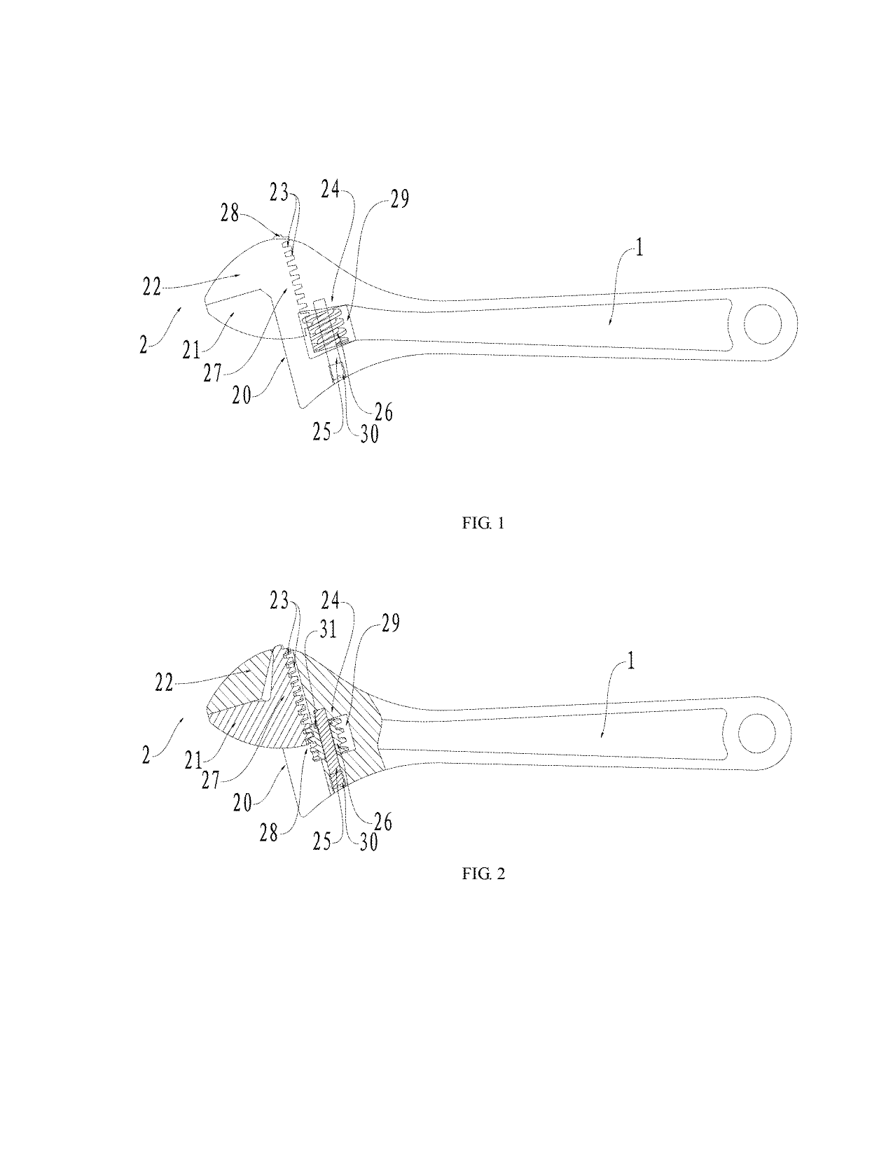

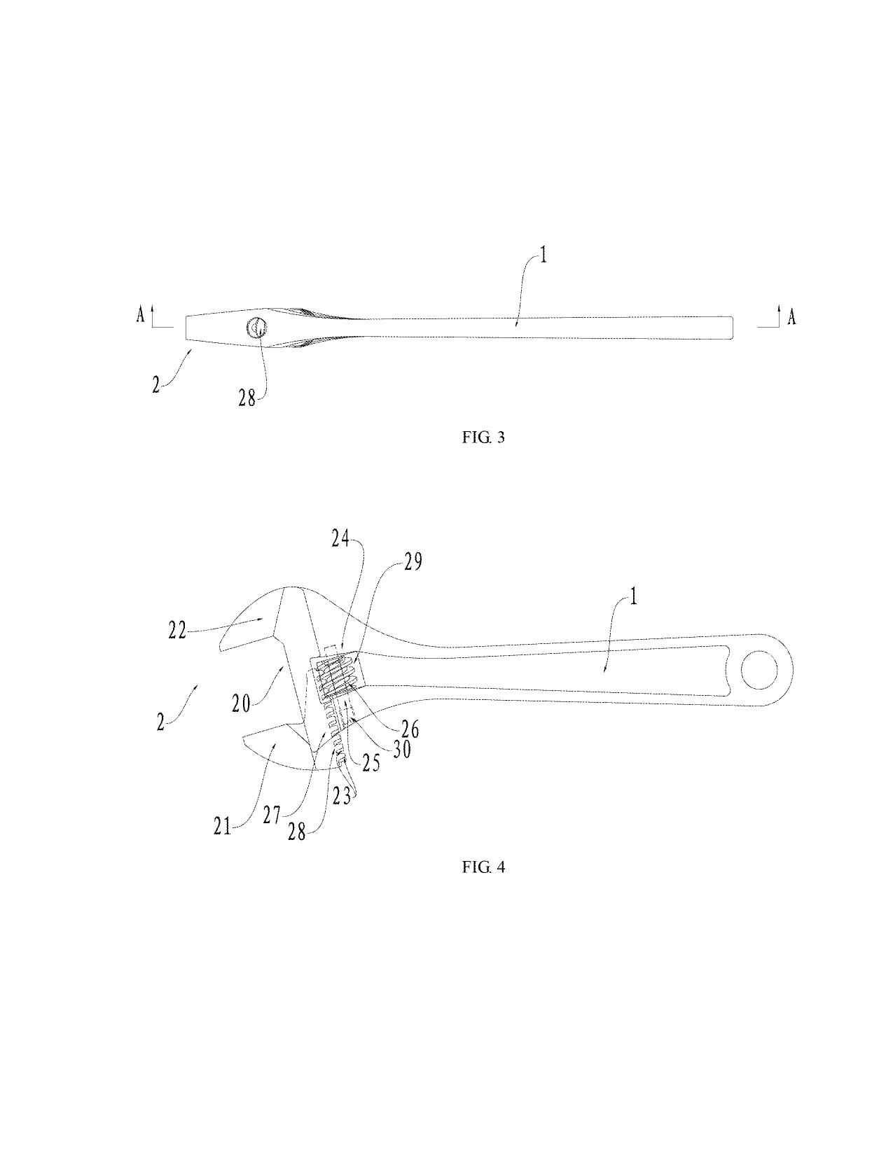

As shown in FIG. 1, the adjustable wrench of the first embodiment of the present invention includes a wrench body and a worm 24, and the wrench body includes a handle 1 and a working part 2. The working part includes a fixed member 22, a movable member 21 and a track 20. The fixed member 22 locates on the top end of the wrench body and at the side of the wrench body. The track 20 is close to one end of the fixed member 20 and extends transversely with its both ends in an open status, and a part of the upper end of the track 20 is also in an open status.

The lower end of the movable member 21 is arranged in the track 20, moving in the directions towards or away from the fixed member 22. The lower end of the movable member 21 includes a neck part 27 and a sliding block 28, the sliding block 28 lying in the bottom end of the neck part 27 in an approximately cylindrical shape. The neck part 27 and the sliding block 28 are arranged in the track 20. An approximately half round shape tooth part 23 is arranged at the bottom edge of the sliding block 28, meshing with the thread 26 of the worm 24. In fact, the tooth part 23 forms a worm gear, where the meshing relationship with the worm 24 forms a worm couple.

In other alternative embodiments of the present invention, the sliding block 28 can be approximately in a box shape. Of course, the shape of the sliding block 28 is not limited to be in cylindrical or box shape, as long as the shape enables the sliding blocks 28 to slide in the track 20 smoothly.

In other embodiments of the present invention, the cross-sectional shape of the tooth part 23 can be a triangle, trapezoid or any other shape; as long as it ensures that the tooth part 23 meshes with the thread 26 of the worm 24.

Below the track 20 is also arranged a through hole 29, whose upper end is in communication with the track 20, and whose cross-sectional shape is approximately a rectangle. The worm 24 is installed in the through hole 29, and the thread 26 of the worm 24 has two starts meshing with the tooth part 23 at the bottom edge of the sliding block 28. As the thread 26 of the worm 24 meshes with the tooth part 23 at the bottom edge of the sliding block 28, the movable member 21 can be driven to move in the directions towards or away from the fixed member 22 when an operator's thumb rolls the worm 24, so that the space between the movable member 21 and the fixed member 22 can be adjusted according to the sizes of work pieces (such as, nuts).

In other embodiments of the present invention, the cross-sectional shape of the through hole 29 can be a trapezoid, circle, etc., as long as it is ensured that the worm 24 is contained within the through hole, and the thread 26 of the worm 24 meshes with the tooth part 23 at the bottom edge of the sliding block 28.

The adjustable wrench in the first embodiment of the present invention also includes a pin axle 25 and a pin hole 30. The pin hole 30 is arranged on the wrench body, whose axial position coincides with that of the worm 24. The pin axle extends through the pin hole 30 and is arranged axially to extend through the worm 24. The worm 24 can rotate around the pin axle 25. One end of the pin axle 25 can be set as flush with the top of the pin hole 30.

The adjustable wrench of the first embodiment of the present invention also includes a spring 31, which is arranged between the worm 24 and the wrench body. One end of the spring 31 is engaged against the worm 24 and the other end of the spring 31 is engaged against the wrench body. The pin axle 25 is also arranged to extend through the spring 31. When an operator's thumb rolls the worm 24, the pressure force produced by spring 31 is in the direction of the movable member 31 moving away from the fixed member 22. By the pressure force produced by the spring 31, the worm 24 can not rotate randomly by itself when an operator is not rolling it, so as to ensure the movable member 21 and the worm 24 can bear forces reliably when clamping work pieces.

The fastening torque produced by the thread 26 of the worm 24 is in proportion to the thread angle of the thread 26 of the worm 24, and the thread angle is in proportion to the number of starts. In the first embodiment, the number of starts on the thread of worm 24 is two.

In the first embodiment, in comparison with single-start thread, the double-start thread increases the pitch of a thread by increasing the thread angle, but as the thread angle is increased, if the single-start thread is just simply changed to double-start thread directly in a routine manner, the reliability of the self-lock function between the thread 26 and the tooth part 23 will be impaired, in that when suffering sudden force or continuous forces, the thread will rotate backward and cause the failure of the wrench, or even make the wrench slip away from the nut to cause harm to operators.

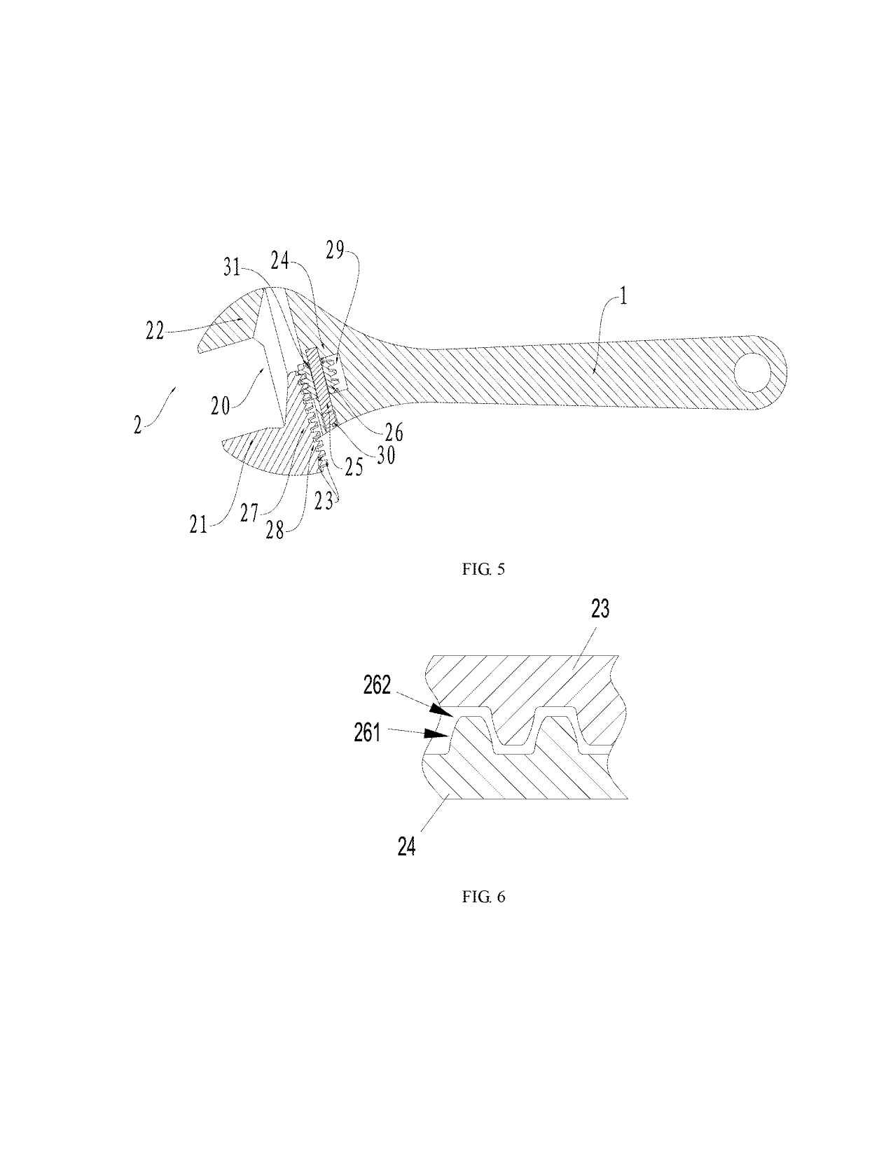

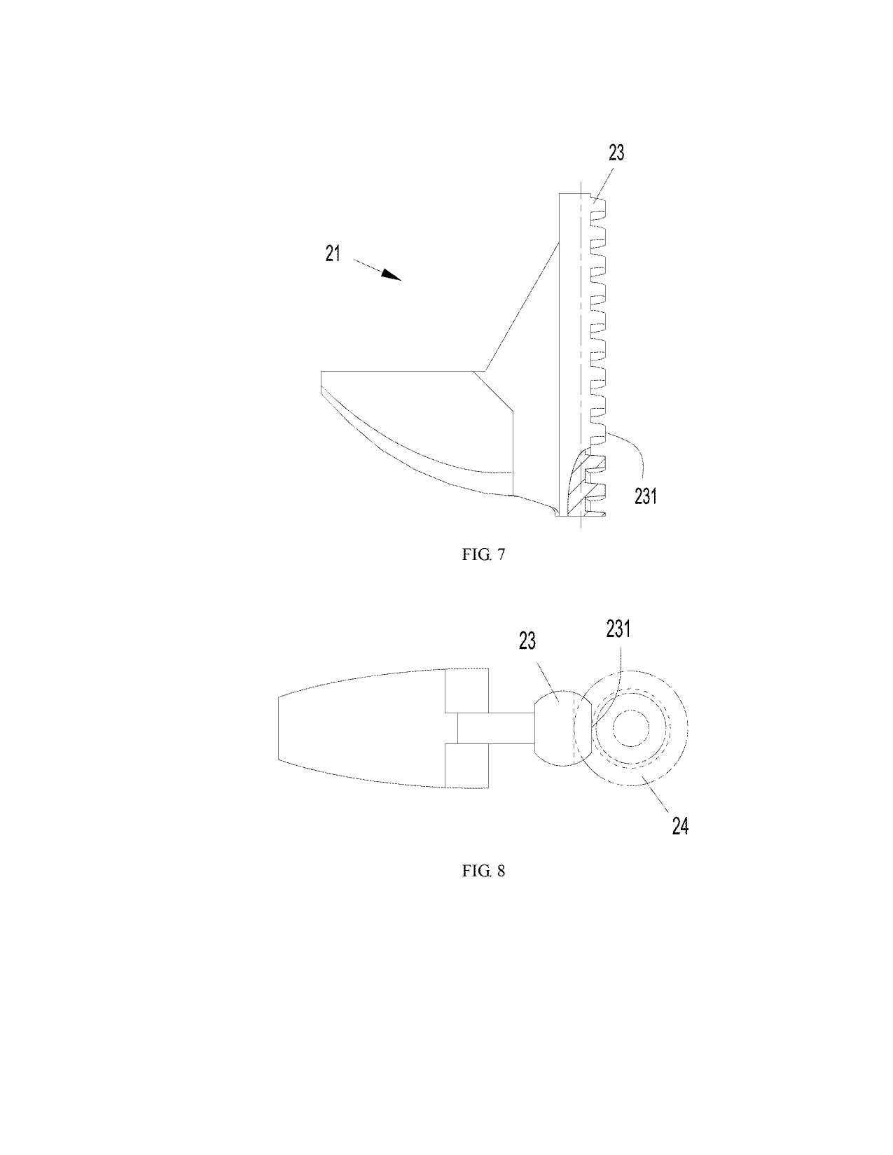

In view of this, in the second embodiment of the present invention, based on the double-start thread in the first embodiment, the tooth profile of the thread 26 is adjusted in a way that the original general trapezoidal thread is changed to having an arc shape surface 261, and in order to avoid interference caused by the change of the tooth shape of the tooth part 23 at the bottom edge of the sliding block 28 during rotation process, the top of the thread 26 is provided with angle 262 to avoid interference, as shown in FIG. 6. But the existence of the angle 262 will decrease the engagement area between the worm 24 and the tooth part 23, which will lower the torque of the wrench, in order to overcome this problem, the present invention has the top of the tooth part 23 of the gear, which belongs to the movable member and is in engagement with the worm, flatten to emerge a surface 231 to allow the worm to come closer to the gear. As is shown in FIG. 7-8, the engagement area between the worm 24 and the tooth part 23 is increased to increase the torque transmission of the wrench.

In the first embodiment, the worm 24 is connected to the wrench body through a cylindrical pin 25, and during the operation of the wrench, what are received by the worm 24 and the tooth part 23 are eccentric forces which transmit through the tooth part 23 to the worm 24, and meanwhile, the worm 24 and the rotation axle are actively connected with certain gap existing therebetween. When the torque of the wrench is strong enough, this torque can cause deformation of the axle 25 that will cause the failure of the wrench, or unsmooth rotation thereof. When the worm 24 is positioned in the square through hole of the wrench 29, the fit between the worm 24 and through hole 29 is clearance fit, and in order to limit the shake of the worm 24, a spring is to be added to one end of the worm 24, but the clearance fit will further cause the forces from the tooth part 23 be transmitted to the cylindrical pin 25.

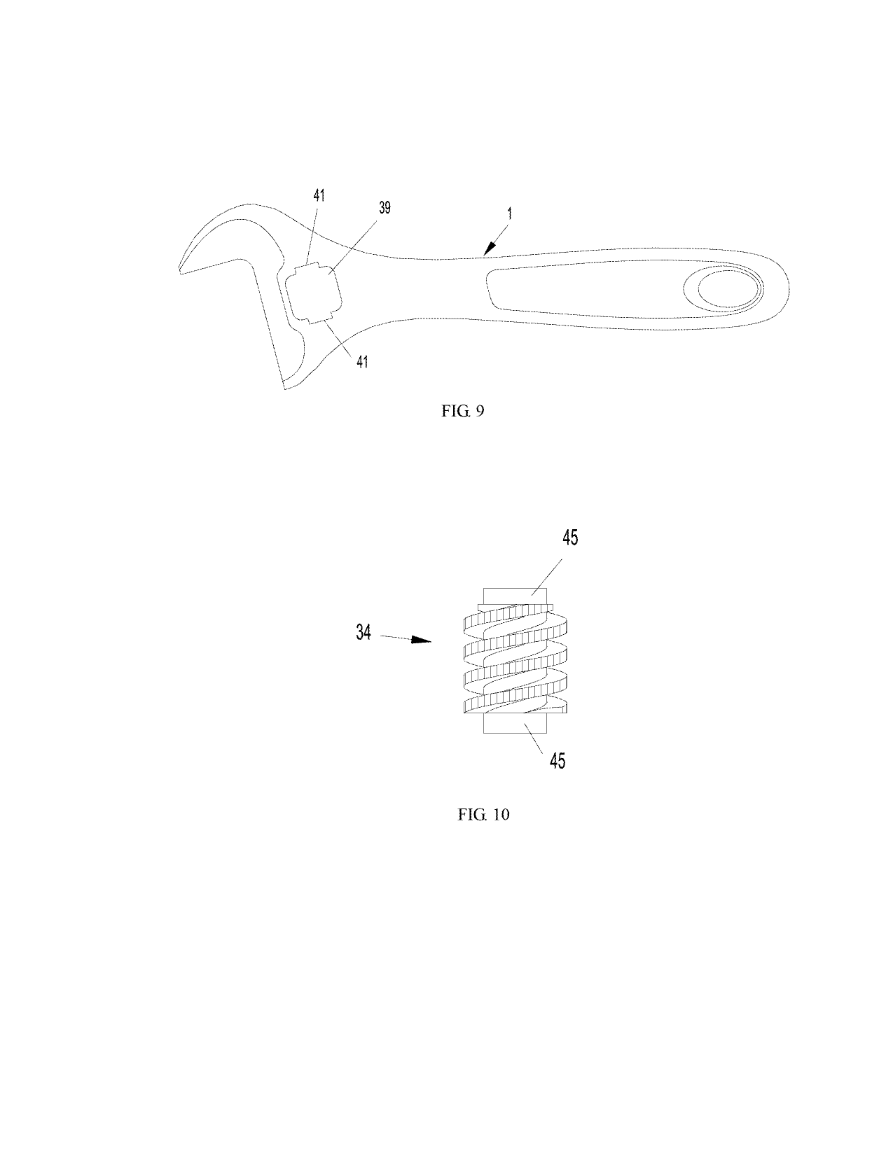

In order to solve the above problem, in the third embodiment of the present invention, two T-shape grooves 41 are added to both sides of the through hole 39 of the wrench body, as shown in FIG. 9; while two bosses 45 are added to the two end surfaces of the worm 34, as shown in FIG. 10. The torque which the worm 34 bears is thus increased by the engagement between the boss 45 and the T-shape groove 41. In this embodiment, due to the existence of the gaps between each other part of the wrench, certain component force is received by the worm when the wrench is receiving forces, and the component force is stronger when double-start thread is used instead of single-start thread, which further increases the force which the tooth part 23 receives. On one hand, the design of the structure can increase the component force which the worm bears; on the other hand, demand is lowered for the fitting accuracy between the other parts of the wrench.

In other embodiments, the number of starts on the thread of the worm 24 can be three.

The ongoing description details the preferable embodiments of the invention. It should be understood that with the general technique of this field, no inventive work is necessary as to make multiple amendments and changes according to conception of this invention. Therefore, all the technical schemes gained from logical analysis, deductions or limited experiments based on the present invention by technicians in this field, should be considered within the protection range asserted in the Claims.

1. An adjustable wrench, comprising a wrench body and a worm;
the wrench body includes a handle and a working part;
the working part includes a fixed member, a movable member, and a track;
the lower end of the movable member is arranged in the track, wherein bottom edge of the lower end of the movable member is arranged with a tooth part;
the working part also includes a through hole in which the worm is arranged for meshing with the tooth part;
when the worm is rotated, the worm interacts with the tooth part and drives the movable member to move in the directions towards or away from the fixed member; and
wherein number of starts on the thread of the worm is at least two;
wherein a tooth profile of the thread of the worm is in a shape of arc with an angled top thereof;
wherein the adjustable wrench further comprises a pin axle and a pin hole, the pin hole is arranged on the wrench body, the pin axle extends through the pin hole and is arranged to extend axially through the worm, and the worm is rotatable around the pin axle;
wherein the adjustable wrench further comprises a spring which is arranged between the worm and the wrench body, wherein the pin axle is arranged to extend axially through the spring;
wherein the through hole has a T-shape groove on each side, and each of two axial end surfaces of the worm has a boss which matches the T-shape groove when the worm is installed in the through hole;
wherein the worm is connected to the wrench body through the pin axle;
wherein the worm and the pin axle are connected with a certain gap existing therebetween; and
wherein two bosses are provided onto the two end surfaces of the worm for engaging with the T-shape groove.

2-10. (canceled)
